(19) United States
(12) Patent Application Publication
(10) Pub. No.: US 2023/0028749 A1
(43) Pub. Date: Jan. 26, 2023

(54) LIDAR WITH MULTI-RANGE CHANNELS

(71) Applicant: ams Sensors Asia Pte. Ltd, Singapore (SG)

(72) Inventors: Carsten RUSS, Singapore (SG); Bassam HALLAL, Thalwil (CH)

(73) Assignee: ams Sensors Asia Pte. Ltd, Singapore (SG)

(21) Appl. No.: 17/786,069

(22) PCT Filed: Dec. 16, 2020
(86) PCT No.: PCT/SG2020/050750

§ 371 Date: Jun. 16, 2022

Related U.S. Application Data
(60) Provisional application No. 62/951,277, filed on Dec. 20, 2019.

(51) Int. Cl. G01S 17/89; G01S 7/4863; G01S 17/48; G01S 7/481

(52) U.S. Cl. CPC G01S 17/89; G01S 7/4863; G01S 17/48; G01S 7/4815; G01S 17/931

(57) ABSTRACT

A light detection and ranging, LIDAR, system. The system comprises a set of long range channels and a set of short range channels Each channel comprises an illumination source. The illumination sources of the short range channels are each configured to illuminate a respective spatial region defined by a first solid angle from the respective illumination source. The illumination sources of the long range channels are each configured to illuminate a respective spatial region defined by a second solid angle from the respective illumination source. The first solid angle is larger than the second solid angle and an intensity of each illumination source of the long range channels is greater than an intensity of each illumination source of the short range channels. The set of short range channels are configured to detect objects within a first field of view, and the set of long range channels are configured to detect objects within a second field of view.

### TECHNICAL FIELD OF THE DISCLOSURE

The disclosure relates to a LIDAR (light detection and ranging) system, particularly but not exclusively, to a LIDAR system having both long and short range channels, and a method of operating such.

### BACKGROUND OF THE DISCLOSURE

The present disclosure relates to LIDAR systems.

An example of a known LIDAR system 100 is illustrated in FIG. 1. The system comprises a plurality of channels, each of which has an illumination source 101. Each illumination source illuminates a respective spatial volume 102, and the reflected light is picked up by one or more detectors (not shown). The properties of the reflected light (e.g. the time delay between illumination and reflection, or wavelength, and/or the brightness) is used to determine the distance of objects within each spatial region.

The extent of the spatial volume 102 will depend on the solid angle over which the illumination source casts light (i.e. the frame of the illumination), and the maximum range at which an object illuminated by the illumination source can be detected by the detector(s).

There may be a single detector, which detects reflected light from each illumination source (e.g. with the illumination sources being activated sequentially), or there may be a detector for each illumination source, configured to detect light reflected from each object in the respective spatial volume.

Some problems associated with such known LIDAR systems are the compromises necessary between range, and eye safety. Obtaining a longer detection range for a LIDAR system requires higher intensity of illumination. However, where the system may be used around people or animals (e.g. on autonomous vehicles), a high intensity could cause damage to the eyes of anyone within the illuminated region. As such, the intensity of LIDAR systems must be limited for safety purposes—but this reduces their effective range, and hence their usefulness. Additionally, greater intensity of illumination requires greater power input, so there is also a compromise between energy usage and range.

It is therefore an aim of the present disclosure to provide a LIDAR system and/or method of operating such that address one or more of the problems above or at least provides a useful alternative.

### SUMMARY

According to a first aspect, there is provided a light detection and ranging, LIDAR, system. The LIDAR system comprises a set of long range channels and a set of short range channels. Each channel comprises an illumination source. The illumination sources of the short range channels are each configured to illuminate a respective spatial region defined by a first solid angle from the respective illumination source. The illumination sources of the long range channels are each configured to illuminate a respective spatial region defined by a second solid angle from the respective illumination source. The first solid angle is larger than the second solid angle and an intensity of each illumination source of the long range channels is greater than an intensity of each illumination source of the short range channels. The set of short range channels are configured to detect objects within a first field of view, and the set of long range channels are configured to detect objects within a second field of view.

Each illumination source may comprise a VSCEL and a lens. The VSCELs may be arranged in an array, and the lenses may be arranged in a corresponding multi-lens array. The VSCEL array may be on a single chip, and the multi-lens array may be on a single substrate.

The LIDAR system may comprise one or more further sets of channels. The illumination sources in each further set of channels may be configured to illuminate objects in a spatial region defined by a respective solid angle, and the intensity of each illumination source in each of the further sets of channels may be set such that sets of channels having greater solid angle have lower intensity, and vice versa.

The first field of view may be encompassed by the second field of view.

The LIDAR system may further comprise an optical detector and a processor. The optical detector and the processor may be coupled to each other and to the illumination sources, and the processor may be arranged to operate the illumination sources depending on the signal received from the optical detector.

According to a second aspect, there is provided a method of operating a LIDAR system. The LIDAR system comprises a set of long range channels and a set of short range channels, each channel comprising an illumination source. For each illumination source of the short range channels, a respective spatial region defined by a first solid angle from the illumination source is illuminated. For each illumination source of the long range channels, respective spatial region defined by a second solid angle from the respective illumination source is illuminated. The first solid angle is larger than the second solid angle and an intensity of each illumination source of the long range channels is greater than an intensity of each illumination source of the short range channels. Objects are detected within a first field of view using the set of short range channels, and objects are detected within a second field of view using the set of long range channels.

The first field of view may be encompassed by the second field of view.

The illumination sources may be operated in response to said detecting of objects.

### BRIEF DESCRIPTION OF THE DRAWINGS

FIG. 1 illustrates a known LIDAR system;

FIG. 2 illustrates an exemplary LIDAR system;

FIG. 3 is a schematic illustration of a LIDAR system similar to that of FIG. 2;

FIG. 4 is a flowchart of a method of operating a LIDAR system.

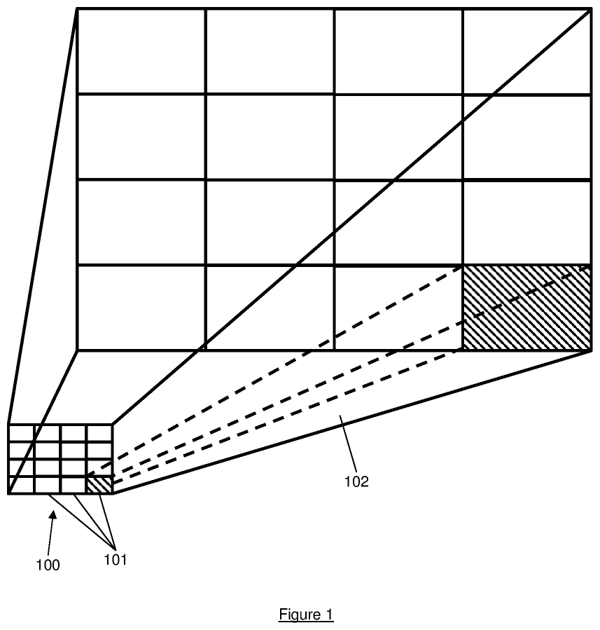

### DETAILED DESCRIPTION OF THE PREFERRED EMBODIMENTS

Generally speaking, the disclosure provides a method of operating a LIDAR system, where both “long range” and “short range” channels are provided, with the long range channels having smaller divergence (i.e. each covering a smaller solid angle), but longer range, compared to the short range channels, and the set of long range channels covering a field of view which is encompassed by of the field of view covered by the short range channels.

Some examples of the solution are given in the accompanying figures.

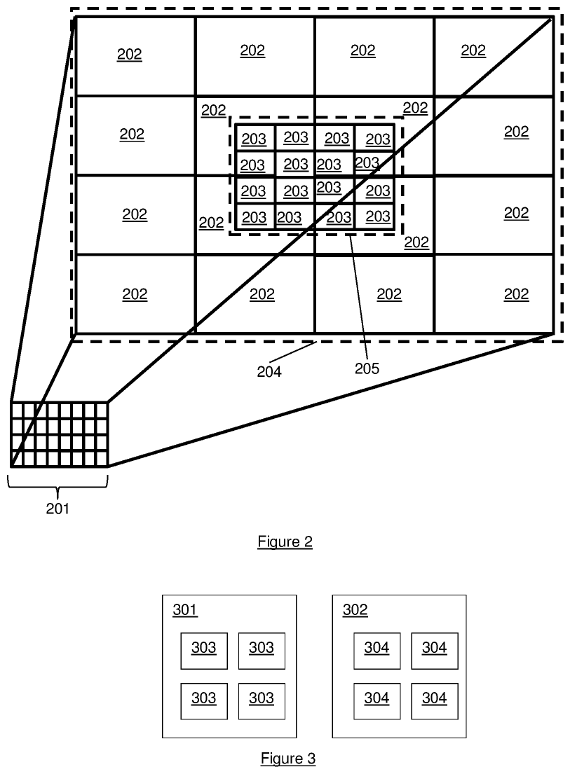

FIG. 2 shows an exemplary LIDAR system. The system comprises a plurality of channels, each comprising an illumination source 201. The channels are divided into long range channels, and short range channels. The short range channels each illuminate spatial volumes 202 having a large angular extent (i.e. solid angle from the illumination source), but short range, and the long range channels each illuminate spatial volumes 203 having a small angular extent, but long range. This is achieved by having the short range channels operate with a lower intensity (i.e. power per unit solid angle) than the long range channels. This may be done while maintaining the same total output power for channels in each set (i.e. the short range channels having a lower intensity as a result of their broader illumination).

Although the illumination sources are illustrated as a rectangular grid of sources, there is no need to have any specific physical arrangement of the illumination sources for the long and short range channels, as the spatial volumes can be defined optically.

The set of short range channels covers a wide field of view 204 (shown by a dotted line). The set of long range channels covers a smaller field of view 205 which lies within the field of view 204 covered by the set of short range channels. In this way, the LIDAR system has long range in a narrow area of interest (e.g. directly in front of an autonomous vehicle), but shorter range over a broader area (e.g. a wider “front view” from the vehicle).

The LIDAR system may be arranged so that all the channels are on a single element—e.g. by providing a VSCEL array and a corresponding multi-lens array, which are configured such that some of the VSCEL/lens pairs provide the long range channels, and others provide the short range channels. The VSCEL array may be on a single chip, and the multi-lens array may be on a single substrate. The different channels may be provided by adjusting the configuration of the multi-lens array (e.g. the focal lengths of the lenses), the VSCEL array (e.g. the output power), or both. Both sets of channels may be operated simultaneously or sequentially, but are typically operated independently. The operation may be dependent on feedback received from optical detectors which detect light reflected back from objects illuminated by the channels.

While the system above has been described with only two sets of channels, it would be possible to provide even more sets—e.g. short, medium, and long range channels (with each set of channels having a different angular extent per channel, and with channels having a larger angular extent having a lower intensity, and vice versa). As a further example, there may be multiple sets of long range channels, each illuminating a different subframe within the frame of the short range channels (e.g. for a system with multiple regions of interest).

For further improvements in eye safety, the LIDAR system may be configured such that the long range channels operate at reduced intensity when an object is detected by the short range channels—i.e. if a person may be close enough for eye safety to be an issue, then the channels operating at an intensity which could cause harm are instead operated at a reduced intensity. Alternatively, the long range channels may be switched off when objects are detected by the short range channels.

FIG. 3 is a schematic illustration of a LIDAR system similar to that of FIG. 2. The LIDAR system comprises a set of short range channels 301 and a set of long range channels 302, each channel comprising an illumination source. While the long and short range channels are shown grouped in this representation, each set need not be physically grouped together. The illumination sources 303 of the short range channels are each configured to illuminate a respective spatial region defined by a first solid angle from the respective illumination source. The illumination sources 304 of the long range channels are each configured to illuminate a respective spatial region defined by a second solid angle from the respective illumination source. The first solid angle is larger than the second solid angle and an intensity of each illumination source of the long range channels is greater than an intensity of each illumination source of the short range channel. The set of short range channels are configured to detect objects within a first frame, and the set of long range channels are configured to detect objects within a second frame which is a subset of the first frame.

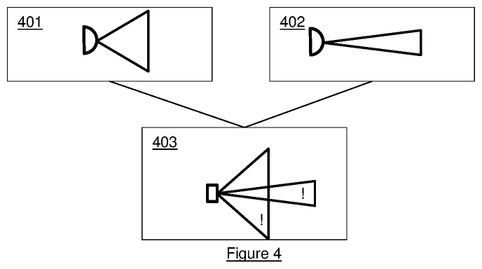

FIG. 4 is a flowchart of a method of operating a LIDAR system, such as the systems shown in FIG. 2 or 3. The LIDAR system has a set of long range channels and a set of short range channels, each channel comprising an illumination source.

In step 401, for each illumination source of the short range channels, a respective spatial region defined by a first solid angle from the illumination source is illuminated. In step 402, for each illumination source of the long range channels, a respective spatial region defined by a second solid angle from the respective illumination source is illuminated. The first solid angle is larger than the second solid angle and an intensity of each illumination source of the long range channels is greater than an intensity of each illumination source of the short range channels.

In step 403 objects are detected within a first frame using the set of short range channels, and objects are detected within a second frame using the set of long range channels, wherein the second frame is a subset of the first frame.

Embodiments of the present disclosure can be employed in many different applications including for autonomous vehicles, scene mapping, etc.

### LIST OF REFERENCE NUMERALS

100 LIDAR system
101 illumination source
102 spatial volume (illuminated by the illumination source)
201 illumination source
202 spatial volume of short range channel
203 spatial volume of long range channel
204 field of view of short range channels
205 field of view of long range channels
301 short range channels
302 long range channels
303 illumination source of short range channel
304 illumination source of long range channel
401 first method step
402 second method step
403 third method step

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

For example, it is envisaged that the present disclosure may be used with both flash LIDAR and scanning LIDAR systems. In flash LIDAR systems, the illumination sources emit a high-energy pulse or flash of light at periodic intervals. The frequency at which the flashes repeat may typically be determined by the desired frame rate or refresh rate for a given use case of the LIDAR system. An example use case where a high frame rate or refresh rate is typically required is in the field of autonomous vehicles where near-real-time visualisation of objects near the vehicle may be required. Light from the illumination sources propagates to objects in a scene where it is reflected and detected by an array of sensors positioned in a focal plane of a lens of the LIDAR system. The time for the light to propagate from the illumination sources of the LIDAR system to objects in the scene and back to the sensors of the LIDAR system is used to determine the distances from the objects to the LIDAR system. Each sensor in the array acts as a receiving element from which a data point may be obtained. Typically, there will be a one-to-one correspondence of illumination sources to sensors. For example, if there are 10,000 illumination sources in an array, the sensor array may comprise 10,000 corresponding sensors. In flash LIDAR, a single flash thus provides the same number of data points as the number of sensors in the system. Accordingly, a large volume of information about a scene being illuminated may be obtained from each flash.

In contrast, in scanning LIDAR systems, the illumination sources emit a continuous pulsed beam of light that scans across a scene to be illuminated. Mechanical actuators that move mirrors, lenses and/or other optical components may be used to move the beam around during scanning. Alternatively, a phased array may be used to scan the beam over the scene. A phased array is typically advantageous as there are fewer moving parts and accordingly a lower risk of mechanical failure of the system. In scanning LIDAR systems, time-of-flight measurements are also used to determine distance from the LIDAR system to the objects of a scene.

Typically, the power emitted by the illumination sources per flash of a flash LIDAR system is high relative to the power of the continuous scanning beam of a scanning LIDAR system. In scanning LIDAR systems, the power of the emitted light is typically lower than flash LIDAR but may still need to be increased to less safe levels to achieve ranges of 30-40 meters as described above. Accordingly, the long and short range channels (and the other improvements described above) may be used equally well with either flash or scanning LIDAR systems.

1. A light detection and ranging, LIDAR, system comprising a set of long range channels and a set of short range channels, each channel comprising an illumination source, wherein:
the illumination sources of the short range channels are each configured to illuminate a respective spatial region defined by a first solid angle from the respective illumination source;
the illumination sources of the long range channels are each configured to illuminate a respective spatial region defined by a second solid angle from the respective illumination source;
the first solid angle is larger than the second solid angle and an intensity of each illumination source of the long range channels is greater than an intensity of each illumination source of the short range channels; and wherein
the set of short range channels are configured to detect objects within a first field of view, and the set of long range channels are configured to detect objects within a second field of view.

2. The LIDAR system according to claim 1, wherein each illumination source comprises a VSCEL and a lens.

3. The LIDAR system according to claim 2, wherein the VSCELs are arranged in an array, and the lenses are arranged in a corresponding multi-lens array.

4. The LIDAR system according to claim 3, wherein the VSCEL array is on a single chip, and the multi-lens array is on a single substrate.

5. The LIDAR system according to claim 1, and comprising one or more further sets of channels, wherein:
the illumination sources in each further set of channels are configured to illuminate objects in a spatial region defined by a respective solid angle;
the intensity of each illumination source in each of the further sets of channels is set such that sets of channels having greater solid angle have lower intensity, and vice versa.

6. The LIDAR system according to claim 1, wherein the first field of view is encompassed by the second field of view.

7. The LIDAR system according to claim 1, further comprising an optical detector and a processor, wherein the optical detector and the processor are coupled to each other and to the illumination sources, and wherein the processor is arranged to operate the illumination sources depending on the signal received from the optical detector.

8. A method of operating a LIDAR system, the LIDAR system comprising a set of long range channels and a set of short range channels, each channel comprising an illumination source, the method comprising:
for each illumination source of the short range channels, illuminating a respective spatial region defined by a first solid angle from the illumination source;
for each illumination source of the long range channels, illuminating a respective spatial region defined by a second solid angle from the respective illumination source;
wherein the first solid angle is larger than the second solid angle and an intensity of each illumination source of the long range channels is greater than an intensity of each illumination source of the short range channels
detecting objects within a first field of view using the set of short range channels, and detecting objects within a second field of view using the set of long range channels.

9. The method of claim 8, wherein the first field of view is encompassed by the second field of view.

10. The method of claim 8, wherein the illumination sources are operated in response to said detecting of objects.
